(19) United States
(12) Patent Application Publication
(10) Pub. No.: US 2021/0222712 A1
(43) Pub. Date: Jul. 22, 2021

(54) Accessory Mount

(71) Applicant: FeraDyne Outdoors, LLC, Superior, WI (US)

(72) Inventors: Isaak M. Waldorf, Cloquet, MN (US); Matthew Peter Haas, Duluth, MN (US)

(73) Assignee: FeraDyne Outdoors, LLC, Superior, WI (US)

(21) Appl. No.: 17/137,851

(22) Filed: Dec. 30, 2020

Related U.S. Application Data
(60) Provisional application No. 62/962,049, filed on Jan. 16, 2020.

(51) Int. Cl. F16B 2/18; F41B 5/14; A01K 87/06; A01K 81/00

(52) U.S. Cl. CPC F16B 2/185; A01K 81/00; A01K 87/06; F41B 5/1488

(57) ABSTRACT

An apparatus for securing an accessory to a device. The apparatus includes an elongated base, a clamp, and a lever. The clamp is defined at least in part by a first section disposed on the elongated base and a second section slidably coupled to the elongated base. The lever is operable for locking and un-locking the second section.

### CROSS-REFERENCE TO RELATED APPLICATIONS

This application claims the benefit of U.S. Provisional Patent Application No. 62/962,049 filed Jan. 16, 2020, which is herein incorporated by reference in its entirety.

### STATEMENT REGARDING FEDERALLY SPONSORED RESEARCH OR DEVELOPMENT

Not applicable.

### TECHNICAL FIELD

The instant disclosure pertains to an apparatus for securing an accessory to a device. In particular, this disclosure relates to an apparatus for removably securing a bowfishing reel to a bow.

### BACKGROUND

The sport of bowfishing combines the sports of archery and fishing. This creates a need for removably securing a key piece of fishing equipment, e.g., a fishing reel, to an archery equipment, e.g., a bow. Typically, fishing reels are mounted directly onto the frame of the bow using a fastener such as for example a screw or bolt. As such, it is not convenient to easily and quickly change the fishing reel in the field. For instance, the archer cannot easily and quickly exchange the installed fishing reel with another having a stronger or weaker fishing line. During use, fishing reels are subjected to wear and tear due. It is also not uncommon for fishing reels to break and/or become unusable.

Conventional fishing reel seats configured for removing and/or replacing a fishing reel attached to the reel seat require tools for loosening and tightening the primary locking mechanism. However, they do not allow the archer to quickly change the fishing reel, and the need to use tools can add complications in a very active and fast paced fishing environment. Bowfishing primarily takes place at night, which further complicates the applicability of such fishing reel seats.

### SUMMARY

An apparatus for securing an accessory to a device. In a non-limiting exemplary embodiment, the apparatus includes an elongated base, a clamp, and a lever. In some embodiments, the clamp is defined at least in part by a first section and a second section. In certain embodiments, the first section is disposed on the elongated base, and the second section is slidably coupled to the elongated base. In some embodiments, the lever is operably coupled to the second section of the clamp. In certain embodiments, the lever is operable for locking and un-locking the second section.

### BRIEF DESCRIPTION OF THE DRAWINGS

FIG. 1 is a perspective view of a non-limiting exemplary embodiment of an apparatus of the instant disclosure;

FIG. 2A is a side view of the apparatus of FIG. 1;

FIG. 2B is a cross-sectional view of FIG. 2A;

FIG. 3A is another side view of the apparatus of FIG. 1;

FIG. 3B is a cross-section view of FIG. 3A;

FIG. 4A is a perspective view of a non-limiting exemplary embodiment of a coupling mechanism for the apparatus of FIG. 1;

FIG. 4B is a side view of the coupling mechanism of FIG. 5;

FIG. 5 is a partial perspective view of the apparatus of FIG. 1;

FIG. 6A is another partial perspective view of the apparatus of FIG. 1;

FIG. 6B is a top (plan) view of FIG. 6A; and

FIG. 7 is a side view illustrating a method of coupling an accessory to the apparatus of FIG. 1.

### DETAILED DESCRIPTION

One or more non-limiting exemplary embodiments are disclosed herein with reference to the accompanying drawings, wherein like numerals indicate like, but not necessarily identical, elements. It should be clearly understood that the embodiments described with reference to the drawings are merely exemplary in that any one or more of them may be implemented in alternative manner as may become apparent to a person of ordinary skills. The figures are not necessarily to scale. Specific structural and/or functional features and details disclosed herein are not to be construed as limiting but should rather be treated as a basis for teaching one of ordinary skills. There is no intent, implied or otherwise, to limit the disclosure in any way, shape or form to the embodiments illustrated and described herein. Accordingly, all variants for providing structures and/or functionalities similar to those described herein for the exemplary embodiments are considered as being within the metes and bounds of the instant disclosure.

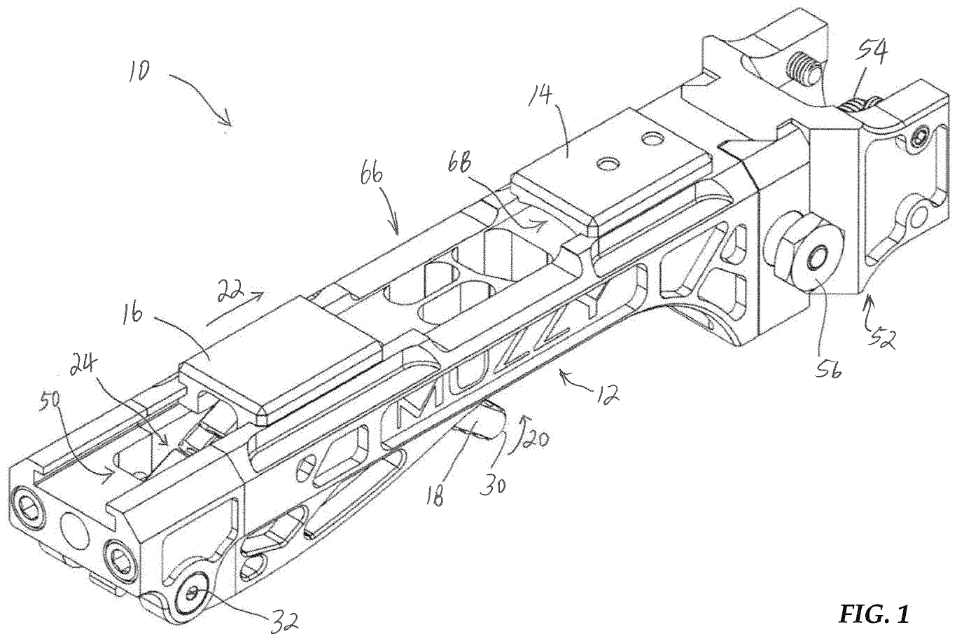

FIG. 1 is a perspective view of a non-limiting exemplary embodiment of an apparatus 10 of the instant disclosure. In some embodiments, the apparatus 10 is defined at least in part by an elongated base 12, a clamp defined at least in part by a first section 14 and a second section 16, and a lever 18 operatively coupled to the second section 16.

In a non-limiting exemplary embodiment, the first section 14 is disposed on at least a portion of the elongated base 12, and the second section 16 is slidable coupled to at least a portion of the elongated base 12. In some embodiments, the elongated base 12 and the second section 16 have complementary features configured for enabling the second section 16 slide along at least a portion of the elongated base 12. In certain embodiments, the elongated base 12 and the second section 16 have complementary tongue-and-groove features slidably coupling them to each other.

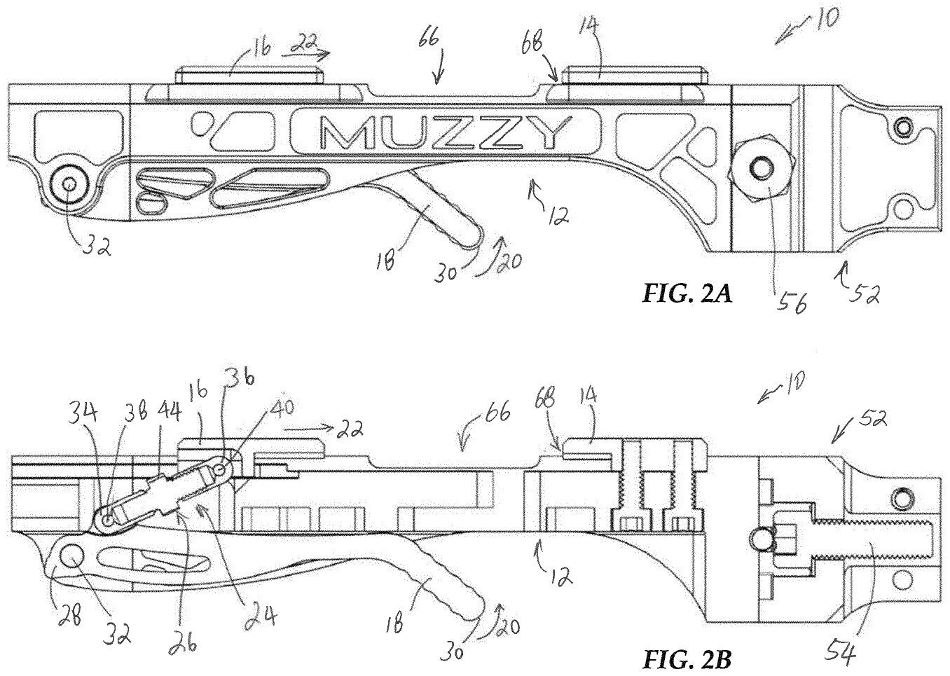

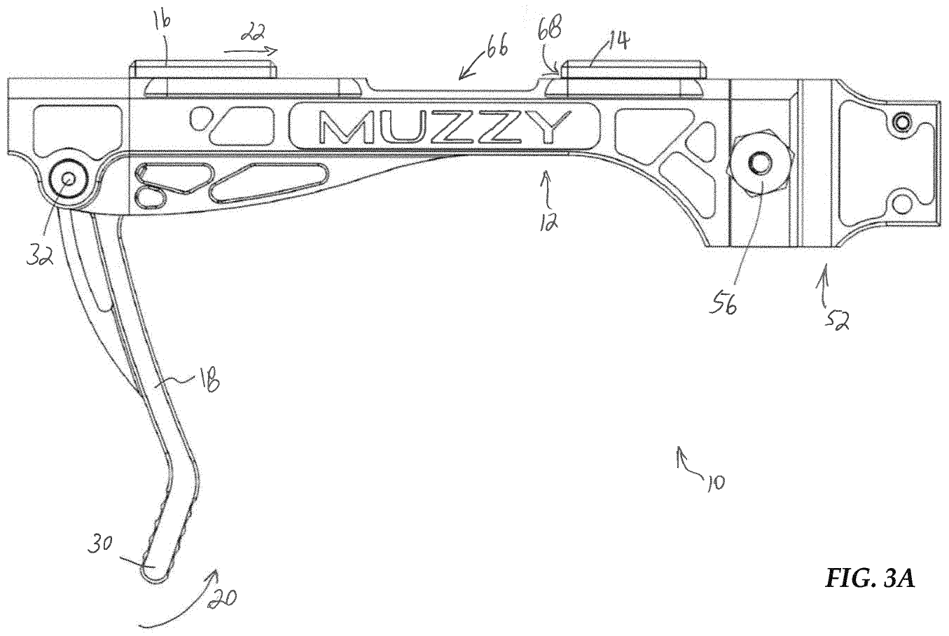

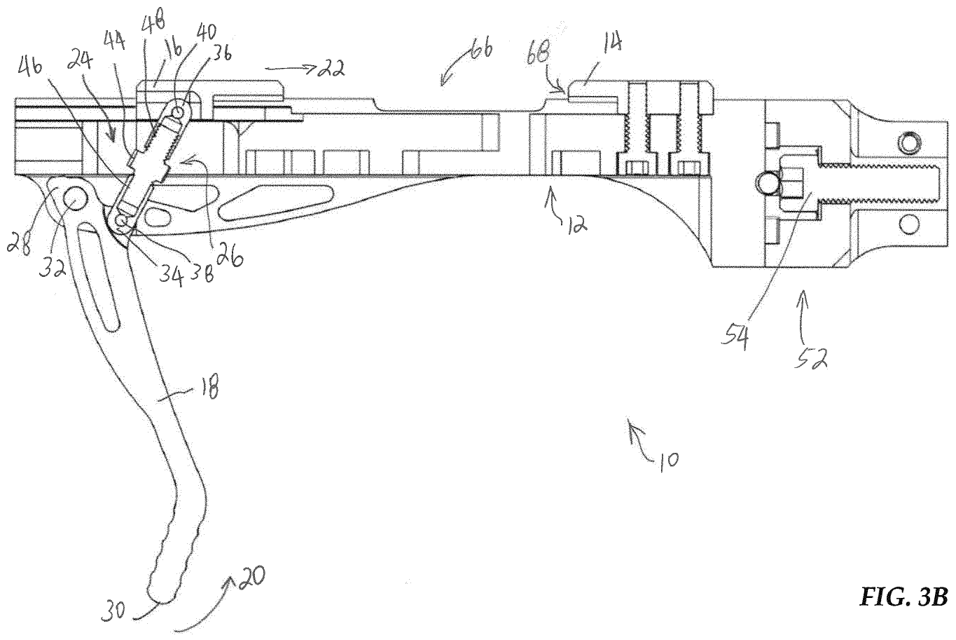

In a non-limiting exemplary embodiment, the lever 18 is operable for sliding the second section 16 along the elongated base 12 and for locking and un-locking the second section 16. FIG. 2A is a side view of the apparatus 10 illustrating an exemplary positioning of the lever 18 and the locked section 16 and FIG. 2B is a cross-sectional view thereof. FIG. 3A is a side view of the apparatus 10 illustrating an exemplary positioning of the lever 18 and the un-locked section 16 and FIG. 3B is a cross-sectional view thereof.

In a non-limiting exemplary embodiment, displacing the lever 18 in a first direction 20 towards the elongated base 12 slides the un-locked second section 16 in a first direction 22 towards the first section 14 until the second section 16 locks on the elongated base 12. Displacing the lever 18 in a second direction opposite the first direction 20 and away from the elongated base 12 un-locks the second section 16 from the elongated base 12 and slides the un-locked second section 16 in a second direction opposite the first direction 22 and away from the first section 14.

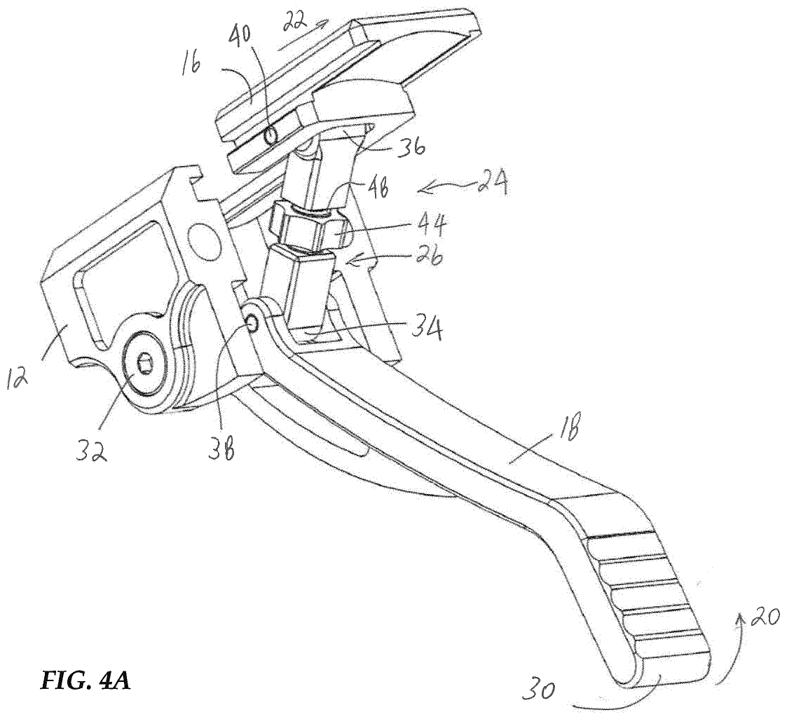

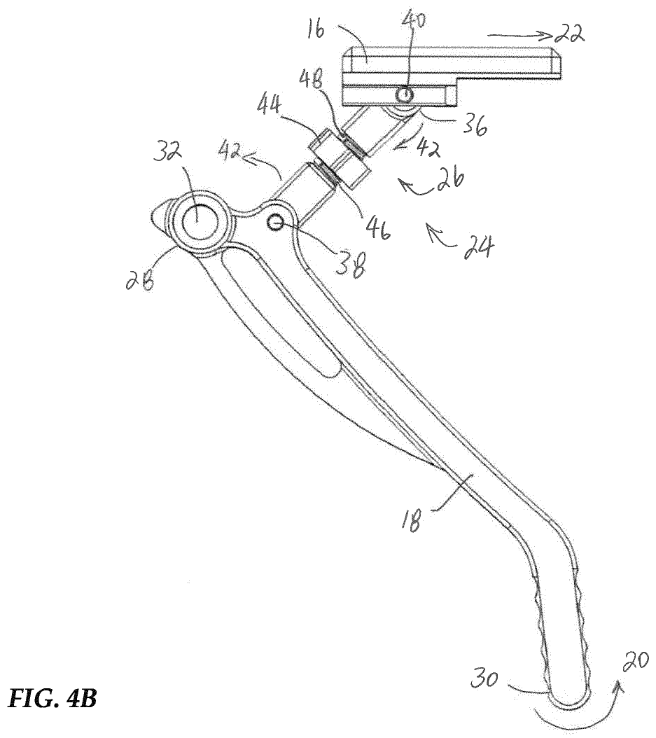

With reference to the cross-sectional views of the apparatus 10, FIGS. 2B and 3B illustrate a non-limiting exemplary embodiment of a mechanism 24 configured for operatively coupling the second section 16 and the lever 18. FIG. 2B illustrates the coupling mechanism 24 in the locked position, and FIG. 3B illustrates the coupling mechanism 24 in the un-locked position. FIGS. 4A and 4B, respectively, are a perspective view and a side view of the coupling mechanism 24. In a non-limiting exemplary embodiment, the coupling mechanism 24 includes a linkage 26 for operatively coupling the second section 16 and the lever 18.

In some embodiments, the lever 18 is defined at least in part by first and second ends 28 and 30, respectively. In certain embodiments, the first end 28 of the lever 18 is pivotally coupled to the elongated base 18 at a pivot point 32 about which the lever 18 is rotatable relative to the stationary elongated base 12. In some embodiments, the lever 18 is pivotally coupled to the elongated base 18 at a pivot point 32 proximate the first end 28 of the lever 18 about which the lever 18 is rotatable relative to the stationary elongated base 12. In other words, the elongated base 12 and the lever 18 are not pivotally coupled at the first end 28 of the lever 18, but instead they are pivotally coupled at a location proximate the first end 28 of the lever 18.

In a non-limiting exemplary embodiment, the linkage 26 is defined at least in part by first and second ends 34 and 36, respectively. In certain embodiments, the first end 34 of the linkage 26 is pivotally coupled to the lever 18 at a pivot point 38 proximate the first end 28 of the lever 18. In some embodiments, the first end 34 of the linkage 26 is pivotally coupled to the lever 18 at a pivot point 38 proximate the pivot point 32. In certain embodiments, the first end 34 of the linkage 26 is pivotally coupled to the lever 18 at the pivot point 32. In some embodiments, the second end 36 of the linkage 26 is pivotally coupled to the second section 16 at a pivot point 40 about which the linkage 26 is rotatable relative to the second section 16.

Now, with particular reference to FIG. 4B, it is seen that with the first end 28 of the lever 18 pivotally coupled to the stationary elongated base 12, displacing or rotating the lever 18 in the first direction 20 towards the stationary elongated base 12 displaces the linkage 26 in a first direction 42 resulting in the second section 16 sliding in the first direction 22 along the elongated base 12 towards the first section 14. In a non-limiting exemplary embodiment, the coupling mechanism 24 is configured for locking, and inhibiting further displacement or movement of the second section 16 and the lever 18 at the end of the rotation or displacement of the lever 18 in the first direction 20, i.e., when the lever 18 abuts or is proximate the elongated base 12. Displacing or rotating the lever 18 in the second direction opposite the first direction 20 un-locks the coupling mechanism 24. It is seen that with continued displacement or rotation of the lever 18 in the second direction opposite the first direction 20 away from the stationary elongated base 12 displaces the linkage 26 in a second direction opposite the first direction 42 resulting in the second section 16 sliding in the second direction opposite the first direction 22 along the elongated base 12 away from the first section 14.

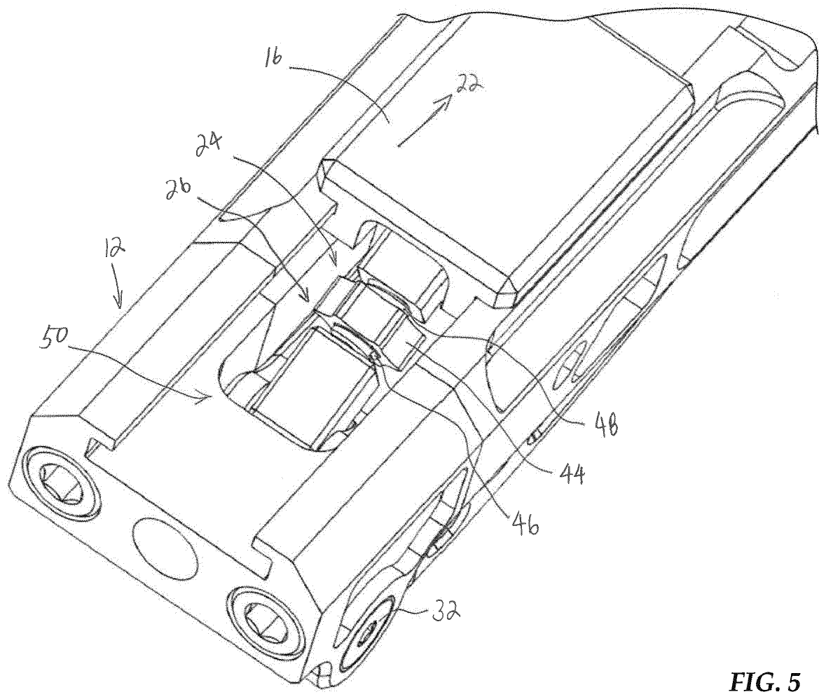

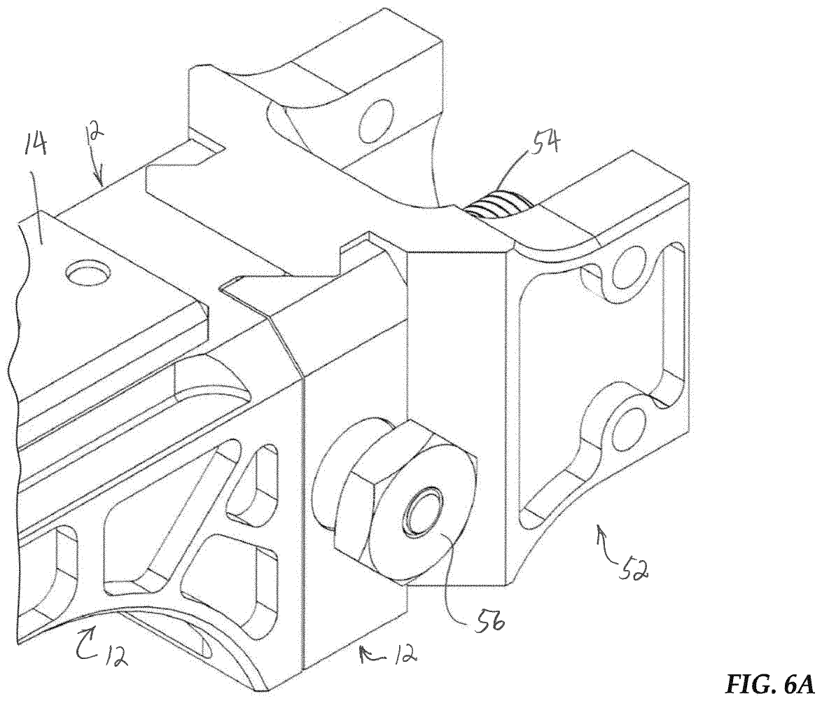

In a non-limiting exemplary embodiment, the coupling mechanism 24 is configured for adjust an amount of force or tension required for locking and un-locking the second section 16 and the lever 18. FIG. 5 is a partial perspective view of the apparatus 10 illustrating accessibility to the coupling mechanism 24. In some embodiments, the linkage 26 include a rotatable “thumb piece” or “head” 44 having oppositely threaded shanks 46 and 48 extending away from opposing sides of the “thumb piece” 44. In certain embodiments, only one of the shanks 46 and 48 is threaded while the other shank is configured for sliding engagement. In some embodiments, the “thumb piece” 44 is accessible through an opening 50 in the elongated base 12. In a non-limiting exemplary embodiment, rotating the “thumb piece” 44 in a first direction increases the amount of force or tension required for locking and un-locking the second section 16 and the lever 18. And, rotating the “thumb piece” 44 in a second direction opposite the first direction decreases the amount of force or tension required for locking and un-locking the second section 16 and the lever 18. Accordingly, it will be readily apparent to a person of ordinary skills that the described exemplary embodiment for locking and un-locking is substantially similar to that of a Vise-Grip plier or locking pliers as are well-known in the art.

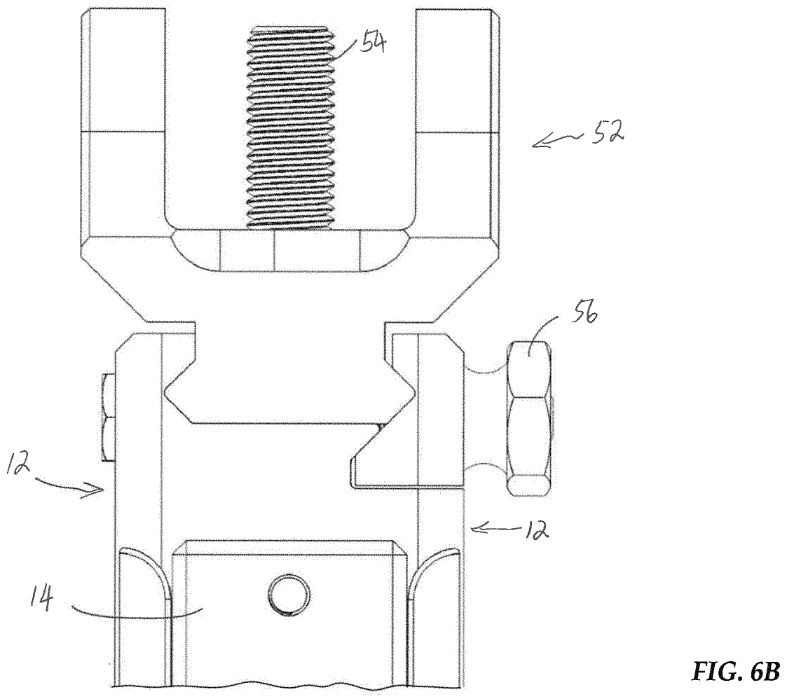

In a non-limiting exemplary embodiment, the apparatus 10 includes a mount 52 configured for securing or attaching the elongated base 12 to a device (not shown). FIG. 6A is a partial perspective view of the elongated base 12 coupled to the mount 52 and FIG. 6B is a top or plan view thereof. In some embodiments, the apparatus 10 includes a first fastener 54 for securing the mount to the device. In certain embodiments, the elongated base 12 and the mount 52 have complementary features (e.g., contours or geometries and such) for being removably coupled to each other. In a non-limiting exemplary embodiment, the elongated base 12 and the mount 52 have a tongue-and-groove configuration. In some embodiments, the apparatus 10 includes a second fastener 56 for removably securing the elongated base 12 and the mount 52 to each other.

In use, the mount 52 is positioned on a frame of the device and secured thereto by the first fastener 54. Next, the elongated base 12 and the mount 52 are coupled or attached and secured to each other by the second fastener. This arrangement provides the user the flexibility to remove the elongated base 12, and any accessory secured thereto, as may be desirable for storing or stowing the device. Another potential advantage of such an arrangement is that it provides the user the option to exchange or swap the elongated base 12 for another elongated base similarly configured for securement to the mount 52. A further potential advantage of such an arrangement is that it provides the user the option to exchange or swap the elongated base 12 for another device or apparatus similarly configured for securement to the mount 52.

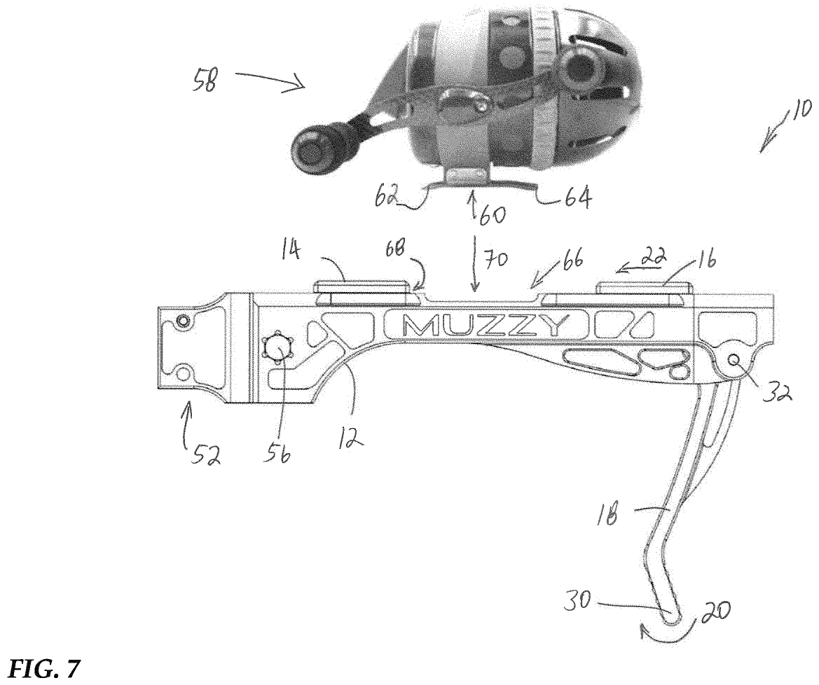

FIG. 7 is a side view of a non-limiting exemplary embodiment of an accessory 58 configured for being removably secured to a device (not shown) using the apparatus 10. In some embodiments, the accessory 58 includes a mounting base 60 having first and second ends 62 and 64, respectively. In a non-limiting exemplary embodiment, the elongated base 12 includes a receptacle 66 for receiving at least a portion of the mounting base 60, and at least the portions of the elongated base 12 adjacent the first and second sections 14 and 16, respectively, are configured for receiving at least a portion of the first and second ends 62 and 64 of the mounting base 60. In some embodiments, the first section 14 includes a channel 68 adjacent or exposed to the elongated base 12 such as illustrated in FIG. 1 for example. Likewise, although not shown, the second section 16 includes an opposing channel 68 adjacent or exposed to the elongated base 12. In a non-limiting exemplary embodiment, the elongated base 12 and the first section 14 are configured for receiving the first end 62 of the mounting base 60 in an opening at least partially formed by the channel 68 between the elongated base 12 and the first section 14. Likewise, the elongated base 12 and the second section 16 are configured for receiving the second end 64 of the mounting base 60 in an opening at least partially formed by the channel on the second section 16 between the elongated base 12 and the second section 16.

In use, with the second section 16 and the lever 18 un-locked, the mounting base 60 of the accessory 58 is placed in the direction 70 into the receptacle 66 of the elongated base 12 and the first end 62 of the mounting base 60 is placed in the opening between the elongated base 12 and the first section 14. Thereafter, in some embodiments, the lever 18 is displaced or rotated in the first direction 20 towards the elongated base 12 whereby the second section 16 slides along the elongated base 12 in the first direction 22 towards the second end 64 of the mounting base 60 and the first section 14. Consequently, the second section 16 will slide over at least a portion of the mounting base 60 proximate the second end 64 such that the second end 64 and at least the portion of the mounting base 60 proximate thereof is received between the elongated base 12 and the second section 16. Continued rotation or displacement of the lever 18 in the first direction 20 towards the elongated base 12 will cause the coupling mechanism 24 to lock the second section 16 and the lever 18 whereby the accessory 58 will be removably secured on the elongated base 12 between the first and second sections 14 and 16 of the apparatus 10.

In a non-limiting exemplary embodiment, the first section 14 is biased towards the second section 16. In one such embodiment, after the first end 62 of the mounting base 60 is placed in the opening between the elongated base 12 and the first section 14, the biasing force will push or displace the mounting base 60, and more particularly the second end 64 of the mounting base 60, towards the second section 16 and into the opening between the elongated base 12 and the second section 16. The lever 18 is then operated as described herein above to removably secure the accessory 58 on the elongated base 12 between the first and second sections 14 and 16 of the apparatus 10.

For removing the accessory 58 secured to the apparatus 10, the coupling mechanism 24 is un-locked by rotating or displacing the locked lever 18 in the second direction opposite the first direction 20 away from the elongated base 12. Continued rotation or displacement of the lever 18 in the second direction opposite the first direction 20 will displace the second section 18 in the second direction opposite the first direction 22, as described herein above, until the second end 64 of the mounting base 60 is exposed. The accessory 58 can then be removed from the apparatus 10 and, if desired, can be replaced by another similarly configured accessory.

In a non-limiting exemplary embodiment, the lever 18 is a camming lever as are well-known in the art.

In a non-limiting exemplary embodiment, the accessory 58 is a fishing reel. In another non-limiting exemplary embodiment, the accessory 58 is a fishing reel for bowfishing.

In a non-limiting exemplary embodiment, the device is a bow. In another non-limiting exemplary embodiment, the device is a fishing bow.

While the non-limiting exemplary embodiments disclosed herein describe the second section 16 and the lever 18 as being operatively coupled, this should not be construed as a limitation. Other non-limiting exemplary embodiments wherein the first section 14 and the lever 18 are operatively coupled in a similar manner are considered as being within the metes and bounds of the instant disclosure. In one such non-limiting exemplary embodiment, the second section 16 is biased towards the first section 14. Additional non-limiting exemplary embodiments wherein both the first and the second sections 14 and 16 are biased towards each other are also considered as being within the metes and bounds of the instant disclosure. In one such non-limiting exemplary embodiment, a lever or some alternate mechanism is used for locking and un-locking the first section 14 and/or the second section 16 for securing the accessory 58.

While the non-limiting exemplary embodiments disclosed herein describe the apparatus 10 having the first fastener 54 for securing or attaching the mount 52 to the device and having the second fastener 56 for securing or attaching the elongated base 12 to the mount 52, this should not be construed as limiting. In some non-limiting exemplary embodiments, the elongated base 12, and perhaps also the mount 52, include a threaded bore or alternate arrangements for receiving a fastener extending through a frame of the device. In one such non-limiting exemplary embodiment, the fastener extending through the frame further extends through the mount 52 and into the elongated base 12 for securement or attachment to the frame.

Other non-limiting exemplary embodiments wherein the elongated base 12 and the mount 52 are integrally formed are also considered as being within the metes and bounds of the instant disclosure. In one such non-limiting exemplary embodiment of an integrally formed elongated base and mount, a fastener extending through the frame of the device may be provided for securing or attaching the elongated base to the device. In another such non-limiting exemplary embodiment, the elongated base 12 is secured or attached directly to the frame of the device, i.e., “the mount 52” absent.

In view thereof, modified and/or alternate configurations of the non-limiting exemplary embodiments illustrated and described herein may become apparent or obvious to one of ordinary skill. All such variations are considered as being within the metes and bounds of the instant disclosure. For instance, while reference may have been made to particular feature(s) and/or function(s), this disclosure is considered to also encompass any and all equivalents providing functionalities similar to those described herein with reference to the accompanying drawings. Accordingly, the spirit, scope and intent of the instant disclosure embraces all variations. Consequently, the metes and bounds of the instant disclosure are defined by the appended claims and all equivalents thereof.

What is claimed is:

1. An apparatus (10) for securing an accessory (58) to a device, the apparatus comprising:
an elongated base (12);
a clamp, comprising:
a first section (14) disposed on the elongated base; and
a second section (16) slidably coupled to the elongated base; and a lever (18) operable for locking and un-locking the second section.

2. The apparatus of claim 1, wherein
the second section locks when the lever is displaced in a first direction (20); and
the second section un-locks when the lever is displaced in a second direction opposite the first direction.

3. The apparatus of claim 1, wherein
the second section slides towards the first section when the lever is displaced in a first direction (20); and
the second section slides away from the first section when the lever is displaced in a second direction opposite the first direction.

4. The apparatus of claim 1, wherein
the second section slides towards the first section and locks when the lever is displaced in a first direction (20); and
the second section un-locks and slides away from the first section when the lever is displaced in a second direction opposite the first direction.

5. The apparatus of claim 1, comprising a linkage (26) operatively coupling the second section and the lever to each other.

6. The apparatus of claim 5, wherein
the lever comprises a first end (28) and a second end (30), wherein the first end of the lever is pivotally coupled to the elongated base; and
the linkage comprises a first end (34) and a second end (36), wherein
the first end of the linkage is pivotally coupled to the lever proximate the first end thereof; and
the second end of the linkage is pivotally coupled to the second section.

7. The apparatus of claim 6, wherein
the second section slides towards the first section and locks when the lever is displaced in a first direction (20); and
the second section un-locks and slides away from the first section when the lever is displaced in a second direction opposite the first direction.

8. The apparatus of claim 6, wherein the linkage is configured for adjusting a force required for locking and un-locking the second section.

9. The apparatus of claim 1, wherein the first and second sections are configured for receiving at least a portion of a base (60) of the accessory.

10. The apparatus of claim 9, wherein the first section is biased towards the second section.

11. The apparatus of claim 9, wherein the accessory is secured to the apparatus by placing the base of the accessory between the first section and the un-locked second section and then locking the second section.

12. The apparatus of claim 11, wherein the accessory is removable when the second section is un-locked.

13. The apparatus of claim 1, comprising a mount (52) for securing the apparatus to the device.

14. The apparatus of claim 13, wherein the elongated base and the mount have complementary features for being removably attached to each other.

15. The apparatus of claim 1, wherein the lever is a camming lever.

16. The apparatus of claim 1, wherein the accessory is a fishing reel.

17. The apparatus of claim 1, wherein the accessory is a fishing reel for bowfishing.

18. The apparatus of claim 1, wherein the device is a bow.

19. The apparatus of claim 1, wherein the device is a fishing bow.
